(19) United States
(12) Patent Application Publication
(10) Pub. No.: US 2010/0285250 A1
(43) Pub. Date: Nov. 11, 2010

(54) THREE-DIMENSIONAL RADIANT INSULATION BARRIER

(76) Inventor: CRAIG ROGERS, WAUKEE, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/775,089

(22) Filed: May 6, 2010

Related U.S. Application Data
(60) Provisional application No. 61/176,518, filed on May 8, 2009.

(51) Int. Cl. B32B 1/04; B32B 1/00

(52) U.S. Cl. 428/35.7; 428/34.1

(57) ABSTRACT

Components and mechanisms for creating a radiant barrier in an attic are described. The primary components are three-dimensional insulating components that have a reflective surface. The components may be set up by hand to form a radiant insulating layer on an attic floor or on top of existing insulation. The components have a three-dimensional self supporting structure that creates a dead air space between the components and the attic floor or insulation on which they set. Preferably the components will stack in a nested configuration for convenient storage and transport. A fill component may be used to fill in gaps between the larger components and around hard to reach spaces. The fill component may be reflective beads.

### CROSS-REFERENCE TO RELATED APPLICATIONS

This application claims priority under 35 U.S.C. § 120 to provisional application Ser. No. 61/176,518 filed May 8, 2009, herein incorporated by reference in its entirety.

### FIELD OF THE INVENTION

This invention relates generally to systems and structures for insulating attics, and more particularly to reflective insulation barriers.

### BACKGROUND OF THE INVENTION

Radiant barriers are materials that are installed in buildings to reduce summer heat gain and winter heat loss. They reduce building heating and cooling energy usage. A radiant barrier reflects radiant heat back towards it source. Radiant barriers are designed to block the effects of radiant heat gain in homes by reflecting radiant heat rather than absorbing it. They provide substantial energy savings in warm climates. When a radiant barrier is placed on the attic floor, much of the heat radiated from the hot roof is reflected back toward the roof. This keeps the top surface of the insulation cooler than it would have been without a radiant barrier and thus reduces the amount of heat that moves through the insulation into the rooms below. Studies have shown that radiant barriers can lower a cooling bill by between 5 and 10% when used in warm, sunny climates.

The effects of radiant heat gain can be reduced with the aid of highly reflective surfaces. Traditional forms of insulation absorb radiant heat energy. Radiant barriers reflect it. Radiant reflective barriers usually consist of a thin sheet or coating of a highly reflective material, usually aluminum, applied on one or both sides of a number of substrate materials. Radiant barriers can also reduce indoor heat losses through the ceiling in the winter. The net benefit is of radiant barriers for reducing winter heat loss near the ceiling, are still being studied.

What is needed in the art is an economical design that is easy to transport and install to form a radiant barrier.

### BRIEF SUMMARY OF THE INVENTION

According to one embodiment, the present invention is directed to a three-dimensional reflective component that is self supporting, and requires no manipulation to be placed in the three dimensional configuration. A plurality of the components can be placed on an attic floor to form an insulating radiant barrier. The reflective surfaces are raised off of the attic floor to create an open air dead space between the barrier and the attic floor. The components may have vents pre-cut into them to prevent the collection of moisture. Preferably the components will be shaped so that they can be nested and stacked together for easy transportation and storage.

According to another embodiment, small pea-sized reflective beads may be used in conjunction with a larger three-dimensional component in order to fill in around pipes, supports, into corners, and other hard-to-reach places.

According to another embodiment, the present invention is an insulating radiant barrier in an attic. The barrier includes a plurality of discreet insulating components, each of which has a self-supporting upwardly extending portion. The upwardly extending portion has an upwardly facing reflective surface for reflecting radiated heat. Each of the components also has an open end supported by the attic floor. The upwardly extending portion is generally hollow to form a dead air space between the upwardly extending portion and the open end. The radiant barrier may further include a plurality of loose reflective beads covering gaps between the discreet insulating components. The upwardly extending portions of the discrete insulating components may be shaped so that they will stack upon each other in a nested configuration. The upwardly extending portions may have a generally hemispherical shape. The discrete insulating components may include ventilation openings. The upwardly extending portions may be formed by a thermally insulating core with the reflective surface formed by a reflective layer applied to the core. The thermally insulating core may be made from polystyrene.

According to another embodiment of the present invention is a reflective insulating component for use in forming a radiant barrier. The component includes a self-supporting convex body with an outer reflective surface and a hollow inner portion for trapping air between the convex body at a surface on which the component is placed. The convex body may be shaped to stack upon a similarly-shaped body in a nested configuration. The convex body may have a ventilation opening formed through it. The body may include a thermally insulating core that may be made from polystyrene.

### BRIEF DESCRIPTION OF THE DRAWINGS

FIG. 1 is an isometric view of a pan shaped insulating component according to one embodiment of the present invention.

FIG. 2 is an isometric view of a radiant barrier according to the present invention formed from a plurality of the insulating component of FIG. 1.

FIG. 3 is a top plan view of an attic with a reflective insulation barrier according to one embodiment of the present invention.

FIG. 4 is a perspective view of a hemispherical insulating component used in creating the barrier of FIG. 3.

FIG. 5 is a cross sectional view of the insulating component of FIG. 4.

FIG. 6 is a side view of a plurality of the hemispherical insulating components of FIG. 4 in a stacked nesting configuration for storage and transport.

FIG. 7 is a perspective view of a small reflective fill component used in forming the barrier of FIG. 3.

FIG. 8 is a top plan view of an insulating reflective barrier according to another embodiment of the present invention wherein the insulating components have a square base and a semispherical reflective portion.

FIG. 9 is perspective view of an insulating component from FIG. 8 with a square base and a semispherical reflective component.

FIG. 10 is a cross sectional view of the insulating component of FIG. 9.

FIG. 11 shows a plurality of the insulating components according to FIG. 9 in a stacked nested configuration for transport and storage.

FIG. 12 shows a pyramid-shaped insulating component according to another embodiment of the present invention.

FIG. 13 shows a cross sectional view of the pyramid-shaped insulating component of FIG. 12.

FIG. 14 shows a perspective view of a plurality of pyramid-shaped insulating components according to the embodiment of FIG. 12 in a stacked nested configuration for transport and storage.

### DETAILED DESCRIPTION OF PREFERRED EMBODIMENTS

The drawings show various embodiments of insulating components and radiant barriers formed from those insulating components. The insulating components are self-supporting discrete pieces that may be laid out by hand on an attic floor to form a radiant barrier. The discrete components have reflective surfaces that reflect heat in the form of infrared radiation upwardly away from the attic floor. The individual components may also include a raised generally hollow portion below the reflective surface in order to trap air which can serve as an insulating barrier against heat transfer via conduction and convection. Several shapes and embodiments are disclosed in the drawings and description. The comments regarding possible features for one embodiment generally will apply to all of the embodiments, except as it relates to specific slopes.

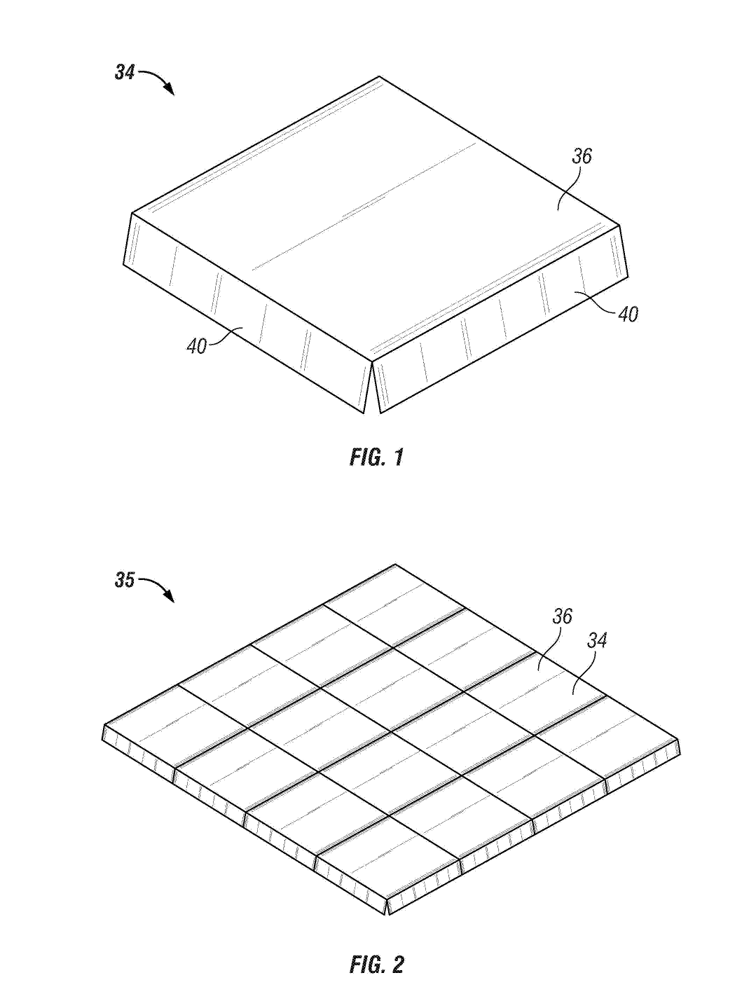

FIG. 1 shows a reflective insulating component 34 according to one embodiment of the present invention. According to this embodiment, the insulating components 34 have a generally rectangular pan shaped configuration. The insulating component 34 may have a composite structure including a solid insulating core covered with a reflective film or coating. The insulating component 34 is formed with a rectangular and preferably square, top plate 36, which can be supported above a surface on which it sits, such as an attic floor, by side plates 40. Accordingly, the insulating component 34 may be created by notching the corners out of a rectangular sheet of material, and bending down flat to form side plates 40. The side plates 40 may be connected with each other to provide structural integrity in order to maintain the top plate 36 in an elevated condition. Preferably, the side plates 40 will not be sealed tightly against each other, so that some ventilation is permitted from the hollow portion formed between the side plates 40 and the top plate 36 when the insulating component 34 is in place on an attic floor.

According to one embodiment, the insulating components 34 are formed from a polystyrene core, which is a flat sheet of polystyrene. The reflective surfaces formed by a metallic foil are adhered to one side of the polystyrene sheet. Preferably the core will be a fire resistant material, such as a soy-based closed cell polystyrene. The side walls 40 are formed by cutting out the corners from a single rectangular sheet of polystyrene with the reflective foil adhered and then creating a crease, either by bending, or by cutting a portion of the polystyrene core along the line that forms the top plates 36. Similar materials are suitable for the embodiments of the other figures as well. Those of ordinary skill in the art will be aware of other suitable materials.

FIG. 2 shows a radiant barrier 35 formed by a plurality of the insulating components 34 that have been laid out on an attic floor. The reflective upper surface of the top plates 36 face generally upwardly to reflect heat radiated from the roof away from the attic floor, such that it helps reduce heat transfer into the building space below the attic floor. The radiant barrier can be formed relatively quickly and easily by hand by setting the insulating components 34 in place on the attic floor. It should be appreciated that based on the configuration of the insulating component 34 shown in FIG. 1, that a plurality of the components can be stacked one upon another in a nested configuration for compact storage of the components 34 used to form the radiant barrier, and for convenient carrying and transport of the components 34 to the attic to be laid out to form the radiant barrier. It should further be appreciated that the hollow spaces formed between the top plate 36 and the attic floor forms a dead air space that further helps in insulating against heat transfer between the building below the attic floor and the exterior of the building.

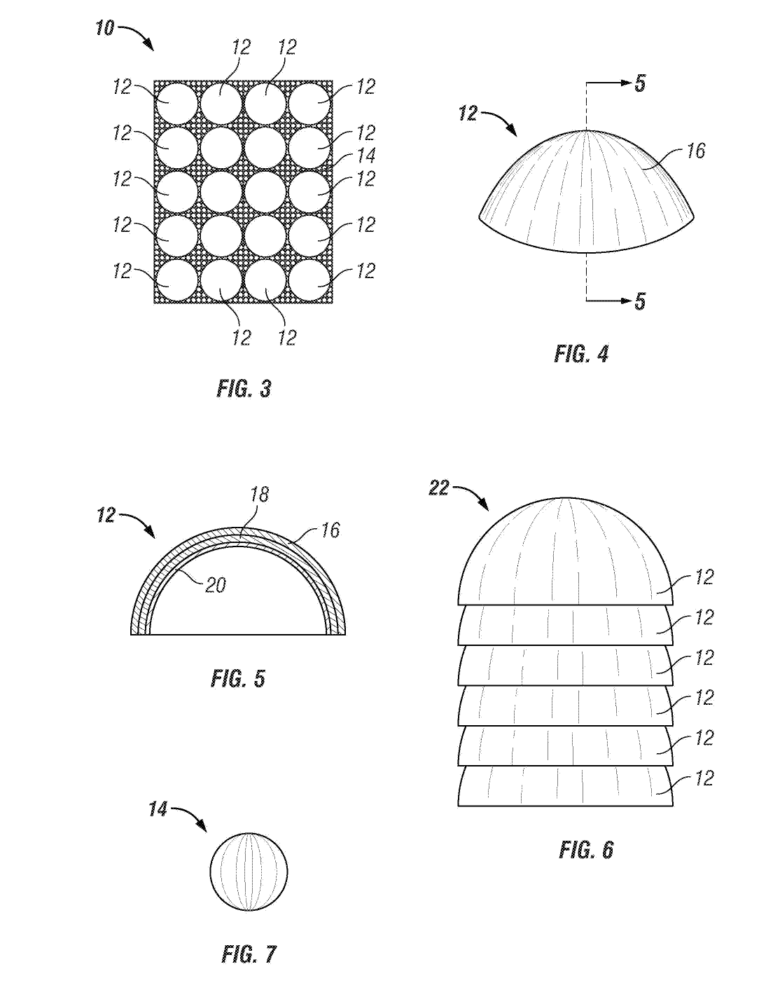

FIG. 3 is a top plan view of an attic floor that has been provided with a reflective radiant barrier 10 according to one embodiment of the present invention. The radiant barrier 10 is formed from semispherical insulating components 12 and reflective fill components 14. The semispherical insulating components 12 provide the primary coverage of the attic floor, and the reflective fill components 14 are used to fill in the spaces between the insulating components 12, and in corners and other hard-to-reach spaces that cannot be effectively covered by the relatively larger semispherical insulating components 12. The semispherical insulating components 12 and reflective fill components 14 are provided loosely on the attic floor, or preferably on the standard insulation blanket, or other standard insulation layer provided in the attic floor.

FIG. 4 shows a perspective view of a semispherical insulating component used to form the reflective radiant barrier 10 shown in FIG. 3. The insulating component 12 has a highly reflective outer surface 16 that will reflect heat that radiates from the roof, and would otherwise be absorbed by the attic floor or traditional insulation layer. The reflective surface should reflect a significant portion of infrared heat radiation. Preferably the reflective surface 16 will have a reflectivity of at least 90%. By having a self-supporting raised geometric shape, such as a semisphere, the insulating component 12 increases the effective surface area as compared to a reflective surface applied directly to the attic floor or insulation layer.

It should be appreciated that while the larger semispherical insulating component 12 is shown as having a semispherical shape, many of the advantages of the invention can be realized with other geometric shapes.

FIG. 5 shows a cross sectional view of the insulating component 12 of FIG. 4. As seen in FIG. 5, the insulating component 12 has a raised self supporting core 18 that is generally shaped as a semisphere in the embodiment of FIGS. 4 and 5. The core 18 may be formed from a variety of materials, but preferably it should be self supporting to maintain the three-dimensional shape without adjustment or manipulation by a user, and preferably will be relatively lightweight, durable, and heat resistant. The core 18 should be sized so that the insulating component 12 is easy to handle and manipulate. According to a preferred embodiment, the insulating component 12 will have a diameter of about 10 inches. As seen in FIG. 5, the reflective outer surface 16 is formed by a reflective coating on the outer surface of core 18. Additionally, according to some embodiments, the insulating component 12 may include a coating 20 on the inner surface of core 18. The inner coating 20 may also be a reflective coating in order to reflect heat back into the attic floor insulation layer; or alternatively, may be an absorptive layer intended to absorb heat from the attic floor insulation layer.

According to a preferred feature of the insulating components 12, they will be shaped so that they can be stacked in a convenient nesting configuration for easy transport and storage of the insulating components 12. A stack 22 of the insulating components 12, as shown in FIG. 6, permits a large number of the insulating components 12 to be stored in a relatively compact space. Additionally, it provides a convenient form for carrying the insulating components to the attic in bulk.

FIG. 7 shows a small reflective fill component 14 used to complete the reflective radiant barrier 10 shown in FIG. 3. According to a preferred embodiment, the reflective fill component 14 is a pea-sized sphere or bead with a reflective outer shell. The reflective fill components 14 can be poured or sprinkled into crevices and other spaces that can't easily be reached or covered with the larger insulating components 12.

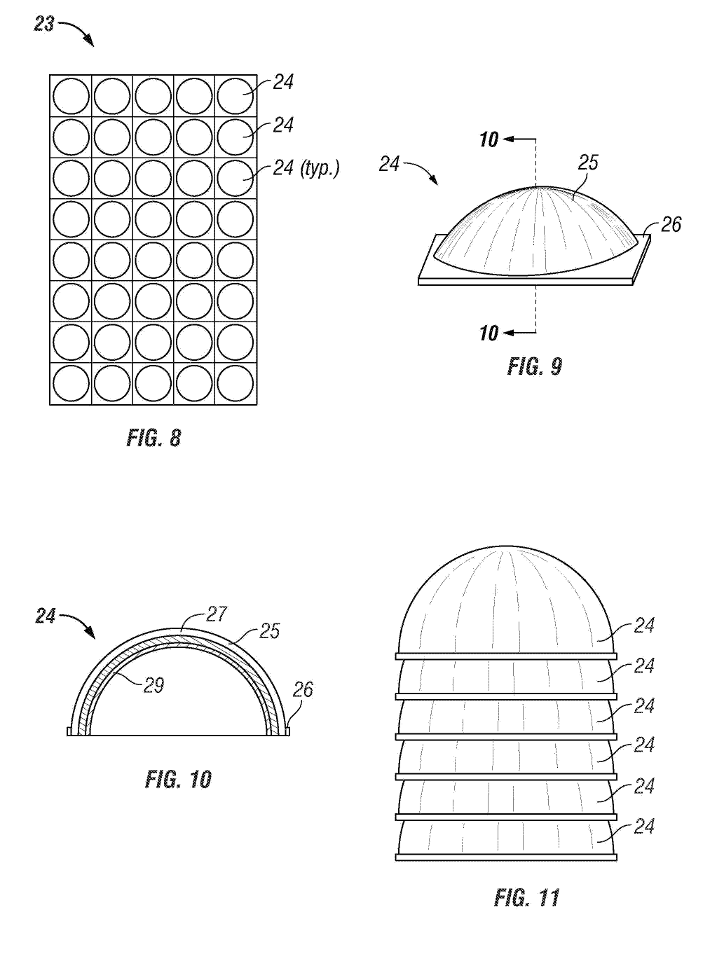

Another embodiment of a three-dimensional reflective insulating component 24 is shown in FIGS. 8-11. An insulating reflective barrier 23 formed from a plurality of the component 24 is shown in FIG. 8. According to the embodiment of the insulating component 24 in FIGS. 9-11, the insulating component 24 has a generally semispherical shaped body 25, similar to the embodiment of FIG. 4, but also includes a square or rectangular base 26 that permits the components 24 to be laid down in a rectangular pattern without any spaces or gaps between each other, as seen in the top plan view of an attic floor shown in FIG. 8. Preferably, the top surface of the rectangular base 26 will be provided with a reflective coating similar to the body 25 of the insulating component 24. The recessed body 25 of the insulating component 24 will also be provided with a reflective coating 27 at least on its exterior surface, and optionally on its internal surface 29. The reflective coating 27 may be a foil, film, paint, or other reflective covering. When set in place on the attic floor or insulation, as shown in FIG. 8, the recessed body 24, as best seen in FIG. 10, will trap a portion of air between the floor insulation and the recessed body 25 of the insulating component 26. This trapped dead air space also serves to provide an additional insulating layer. The insulating component 24 may be provided with slots or other openings to provide ventilation between the trapped dead air space and the air in the attic in order to avoid collecting or trapping moisture within the dead air space. Preferably the insulating components 24 will stack in a nested configuration as shown in FIG. 11 for convenient transport and storage.

It is contemplated that the square or rectangular base design shown in FIGS. 8-11 will reduce the need for the fill components 14; however, the fill components may still be desirable for filling in around areas that cannot be reached by the larger components 24.

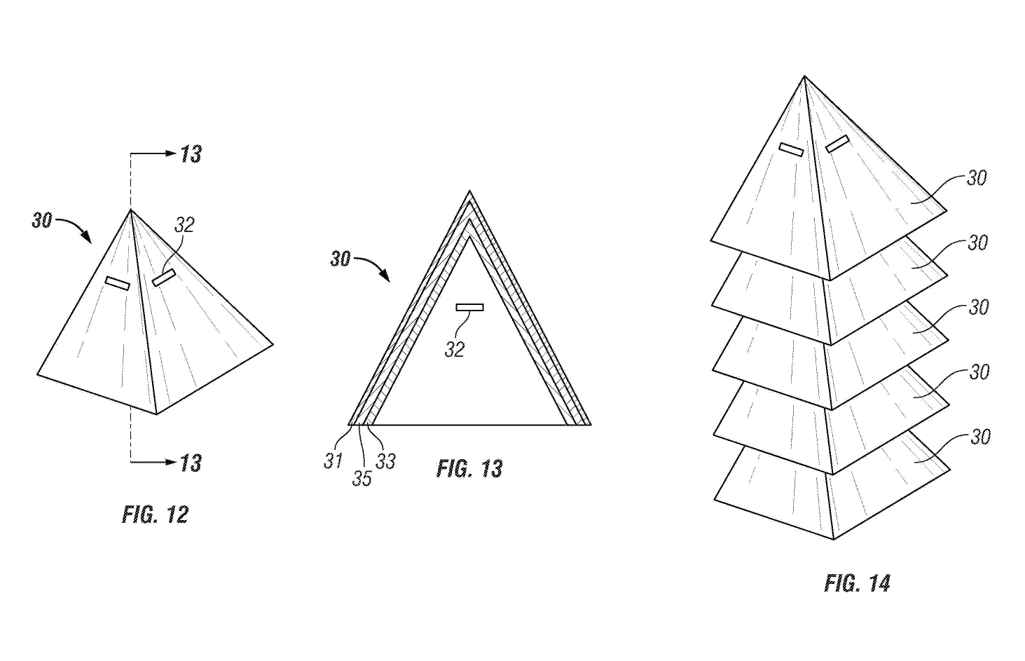

Another embodiment of a reflective insulating component 30 according to the present invention is shown in FIGS. 12-14. According to this embodiment, the insulating component 30 has a pyramid shape. The pyramid-shaped insulating components 30 may be laid out on the floor or insulation of an attic to create a radiant barrier. The external surface of the pyramid should be provided with a reflective coating. The internal surfaces of the pyramid-shaped components 30 may be provided with a reflective coating 33, or in the alternative, an absorptive coating. The structural integrity of the component 30 may be provided by an insulating core 35. As shown in FIGS. 12-14, the pyramid-shaped insulating components 30 may be provided with ventilation openings 32 to avoid trapping moisture in the dead air space created between the inner surfaces of the pyramid-shaped components 30 and the floor or insulation on which it is set. As shown in FIG. 14, the pyramid-shaped components 30 should be suitable for nested stacking on each other for transport and storage.

The above described components and arrangements provide an advantageous mechanism for creating a radiant insulating barrier in an attic. Their nesting and stacking feature permits easy transport and storage of the devices. They can be readily and easily installed by simply laying them out in place on an attic floor or insulated surface. No specialized equipment or training is required for their installation. Additionally, there is some uncertainty whether such radiant barriers are advantageous during colder months when they serve to reflect some of the heat that might otherwise be transferred from the roof that is warmed by sunlight into the space below the attic. Accordingly, one potentially advantageous feature of the above-described components and systems, is that they could be readily stacked up and stored during the winter months, and then easily redistributed during the cooling season.

The presently preferred embodiments of the invention have been described with a degree of particularity. The previous description is of preferred examples for implementing the invention only, and the scope of the invention should necessarily be limited by this description. The scope of the invention is defined by the scope of the following claims.

What is claimed is:

1. An insulating radiant barrier on an attic floor, the barrier comprising:
a plurality of discrete insulating components, each of the components in the plurality having a self-supporting upwardly extending portion having an upwardly facing reflective surface for reflecting radiated heat and an open end supported by the attic floor, the upwardly extending portion being generally hollow to form a dead air space between the upwardly extending portion and the floor.

2. The insulating radiant barrier of claim 1, further comprising a plurality of loose reflective beads covering gaps between the discrete insulating components.

3. The insulating radiant barrier of claim 1, wherein the upwardly extending portions of the discrete insulating components are shaped so that they will stack upon each other in a nested configuration.

4. The insulating radiant barrier of claim 1, wherein the upwardly extending portions have a generally hemispherical shape.

5. The insulating radiant barrier of claim 4, wherein the discrete insulating components include a thermally insulating core.

6. The insulating barrier of claim 1, wherein the upwardly extending portions include ventilation openings.

7. The insulating barrier of claim 1, wherein the upwardly extending portions each have a downwardly facing surface that is reflective.

8. The insulating barrier of claim 1, wherein the upwardly extending portions each have a downwardly facing surface that is coated with an absorptive coating.

9. A reflective insulating component for use in forming a radiant barrier, the component comprising: a self-supporting convex body with an outer reflective surface and a hollow inner portion for trapping air between the convex body and a surface on which the component is placed.

10. The insulating component of claim 9, wherein the convex body is shaped to stack upon a similarly shaped body in a nested configuration.

11. The insulating component of claim 9, further comprising a rectangular base at an open end of the body.

12. The insulating component of claim 9, further comprising a ventilation opening through the convex body.

13. The insulating component of claim 9, wherein an inner concave surface of the convex body is provided with a reflective coating.

14. The insulating component of claim 9, wherein an inner concave surface of the convex body is provided with an absorptive coating.

15. The insulating component of claim 9, wherein the body comprises a thermally insulating core.

16. The insulating component of claim 15, wherein the core comprises polystyrene.
